(19) United States
(12) Patent Application Publication
(10) Pub. No.: US 2009/0271229 A1
(43) Pub. Date: Oct. 29, 2009

(54) METHOD FOR GENERATING A FLEXIBLE MODEL FOR JOINT PROFIT AND ENVIRONMENTAL OPTIMIZATION

(75) Inventors: Baruch Ismail SAEED, Berkeley, CA (US); Karl PERRON, Cincinnati, OH (US)

Correspondence Address: SUGHRUE MION, PLLC, 2100 Pennsylvania Avenue, N.W., Washington, DC, 20037, US

(73) Assignee: C/O OUTPERFORMANCE, INC., Redwood Shores, CA (US)

(21) Appl. No.: 12/108,319

(22) Filed: Apr. 23, 2008

(51) Int. Cl. G06Q 10/00; G06Q 50/00

(52) U.S. Cl. 705/7

(57) ABSTRACT

A method for generating a flexible model for joint profit and environmental optimization. The flexible model comprises an input-to-output activity conversion table being applied on projects, processes, markets, and products of the organization. The conversion table includes a five-step pattern that captures a wide range of conversion behaviors. The flexible model can be effectively utilized to model and optimize environmental initiatives determined by the organization in the context of the organization's profits.

### TECHNICAL FIELD

The present invention relates generally to methods for modeling business plans.

### BACKGROUND OF THE INVENTION

Increasingly, in the current competitive business climate, there is a profit driven motive to maximize the profitability of products and services (collectively referred to as “products”) that are provided or marketed to customers. Enterprises typically use business planning to make decisions in order to maximize profits.

Generally, business planning is the process of acquiring operational information from business units in the organization in order to create, integrate, and execute the next series of operational plans and financial budgets. The process normally entails that each logical organization of the business gathers information from logical sub-organizations, which in turn, themselves gather information from their sub-organizations, up to a desired level of abstraction, usually at product, process and customer levels.

The business information is often collected from multiple data sources, such as individual spreadsheets, online transaction processing (OLTP) applications, and specialized databases, called operational data stores (ODS). The OLTP applications are enterprise systems that manage a company's basic transactions, such as supply chain management (SCM), customer relationship management (CRM), and enterprise resource planning (ERP). Using the business planning tools managers can make decisions that allocate resources in an attempt to maximize profits. For example, key decisions include, but are not limited to, determining which new products to introduce, which suppliers to use, which capital investments to make, and what prices to charge.

In the related art, there are many tools for implementing a business planning process. Some of the conventional tools are based on linear programming models and are often inefficient and time consuming. This is due to the fact that the business planning process must be orchestrated between and across multiple organizations, each of which may have its own information tracking and planning model. To simplify their analyses, organizations typically aggregate detailed information prior to making resource allocation decisions, thereby introducing inaccuracies into the planning process and, potentially, infeasibility into the plans. Furthermore, constraints, such as resource availability, asset (e.g., machine) capacity availability, and maximum potential demand levels by product and customer assigned to such models, may be incompatible. Therefore, the overall planning results are not efficiently, or otherwise globally, optimized.

Sophisticated tools for business planning are piecemeal, are aggregated and fail to capture the myriad of interconnections and tradeoffs that significantly impact the underlying economics of the business. Furthermore, such tools are not feasible for complex organizations that may have multiple business units and multiple interactive production flows. The tools may include, but are not limited to, spreadsheets, activity-based costing systems, simulation and optimization packages.

Another disadvantage of conventional tools is their inability to generate a flexible and effective model of the business plan to be implemented. Generally, a model with consistent mathematics describes the relationships between the applications, processes, and products of the organization based on averaged costs and pricing. Conventional tools generate the model based on users' input, products, processes, projects and their relationships. As a result, many business flows (e.g., operational, cash, etc.) are not modeled, and therefore the overall profit of the organization is not maximized.

The inability to provide a flexible model for modeling the business plan is a major disadvantage in today's business climate. Due to increasing environmental awareness, regulation and social pressure, manufacturers, such as those with chemical processes and fossil fuel-burning plants, must take into consideration environmental factors when implementing their business plans. Examples of such factors include, but are not limited to, a maximum amount of mercury that a chemical plant may emit, offsetting of carbon emissions in a voluntary trading market, purchasing of sulfur dioxide allowances in an emissions market, minimum fuel efficiency for United States auto manufacturers, and so on. These factors must be modeled in order to optimize the profit of the organization.

An example for a conventional modeling process may be found in US patent publication No. 2005/0027577 by Saeed, incorporated herein by reference merely for the useful understanding of the background of the invention. The modeling process of Saeed models projects, processes, and applications of the organization, but does not provide any means to model the environmental factors, and therefore cannot be utilized for business planning of manufacturers that implement environmental production flows.

In view of the limitations of the prior art, it would be therefore advantageous to provide a flexible modeling solution that can be used for joint profit and environmental optimization of organizations.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a computer implemented method for generating a flexible model for joint profit and environmental optimization, a computer program product having instruction adapted to enable a computer to perform the same, and a computer readable medium encoded with a data structure for converting inputs into outputs of a manufacturing process according to variable cost and fixed cost behaviors of the manufacturing process.

According to an aspect of the present invention, there is provided a computer implemented method for generating a flexible model for joint profit and environmental optimization, comprising: modeling one or more initiatives of an organization, said initiatives including at least one environmental initiative of the organization, to form a project layer; modeling the operation of the organization to form a process layer with respect to the one or more initiatives; and for each model layer, determining at least activities of converting inputs into outputs.

According to another aspect of the present invention, there is provided a computer program product for generating a flexible model for joint profit and environmental optimization, the computer program product having computer instructions on a tangible computer readable medium, the instructions being adapted to enable a computer system to perform operations, comprising: modeling one or more initiatives of an organization, said initiatives including at least one environmental initiative of the organization, to form a project layer; modeling the operation of the organization to form a process layer with respect to the one or more initiatives; and for each model layer, determining at least activities of converting inputs into outputs.

According to another aspect of the present invention, there is provided a computer readable medium encoded with a data structure for converting inputs into outputs of a manufacturing process according to variable cost and fixed cost behaviors of the manufacturing process, wherein the data structure comprises five conversion steps including: an input step for designating inputs to the manufacturing process; an application step for designating which of the inputs are required for the manufacturing process; an attempt step for identifying products that can be manufactured by the manufacturing process; a result step for identifying an actual yielded products; and an output step for designating outputs of the manufacturing process.

### BRIEF DESCRIPTION OF THE DRAWINGS

FIG. 1—is flowchart describing the method for generating a flexible model for joint profit and environmental optimization implemented in accordance with an embodiment of the invention.

FIG. 2—is an input-to-output conversion table constructed in accordance with an embodiment of the invention.

FIG. 3—is a connections table constructed in accordance with an embodiment of the invention.

FIG. 4—is a network showing an exemplary modeled process layer.

FIGS. 5A, 5B, 5C and 5D—are examples for input-to-output conversion tables.

### DETAILED DESCRIPTION OF THE INVENTION

In accordance with certain embodiments of the invention, there is provided a method for generating a flexible model for joint profit and environmental optimization. The flexible model comprises an input-to-output activity conversion table being applied on projects, processes, markets, and products of the organization. The conversion table includes a five-step pattern that captures a wide range of conversion behaviors. The flexible model can be effectively utilized to model environmental initiatives determined by the organization.

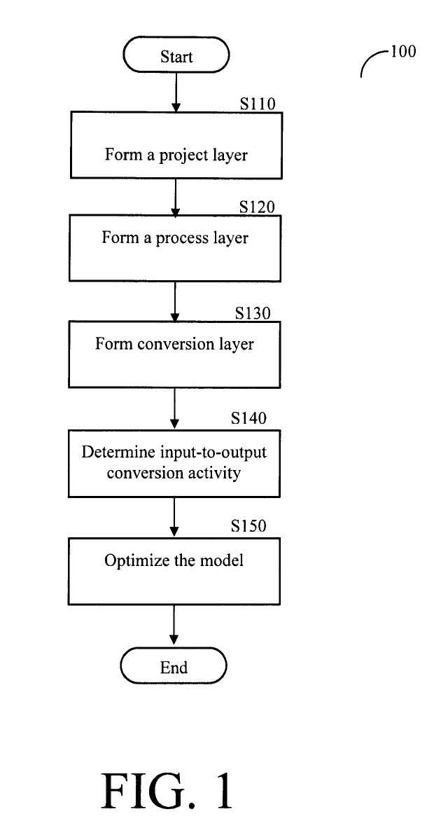

FIG. 1 shows a non-limiting and exemplary flowchart 100 describing a method for generating a flexible model for joint profit and environmental optimization implemented in accordance with an embodiment of the invention. The basic structural elements of the model are projects, processes, products, and periods. Processes convert resources, intermediate products and finished goods. Processes and products may require other products to sustain their existence. Projects may transform, remove or add processes or products, and may transform variables describing how processes operate on products. Projects may require processes and products for their execution. Finally, projects work over time, or different periods. The modeling method captures these structural elements in three layers: project, process, and input-output activity.

At S110, a project layer is formed by modeling at least planning initiatives of the organization as projects with predecessor-successor relationships. The planning initiatives may include strategic level decision that managers consider in order to increase the profit of the organization. For example, products and customers to pursue, the volume of products to pursue, increasing or decreasing the headcount of different divisions in the organization, changing supply chains, and so on. The planning initiatives may also refer to environmental factors, such as reducing the amount of emissions and toxins emitted during manufacturing processes and the amount of nonrenewable energy consumed by the manufacturing process.

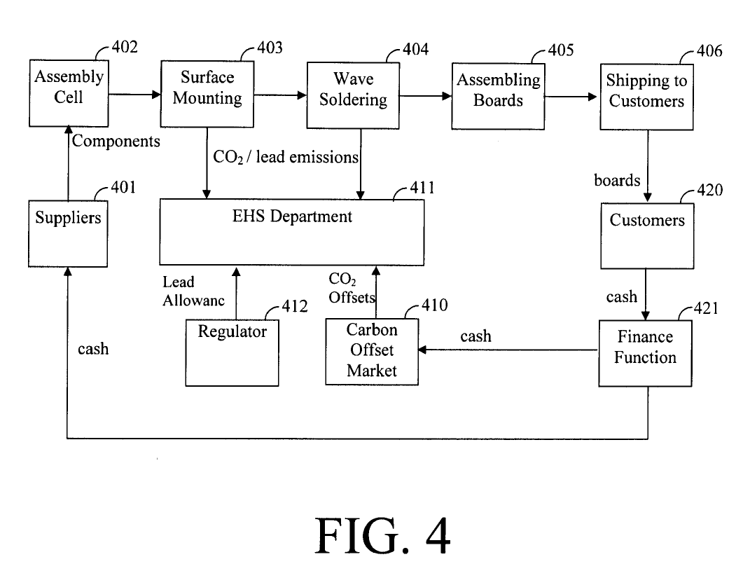

At S120, a process layer is formed by modeling the organization's operations as a network of nodes that represent process elements. For example, the modeled process elements may include, receiving raw material, producing products from raw material, shipping of products, customers, and support functions. The support functions may include functions provided by different divisions of the organization, for example, finance, sales and marketing, information technology (IT), environmental health and safety (EHS), and so on. In accordance with an embodiment of the invention, the process elements include Regulators, governmental organizations who impose environmental constraints that the organization should meet. For example, a Regulator may limit emissions by the organization. Modeling of the process layer results in a network of process elements with directed arcs representing eligible product transfers. A detailed example for such a network is provided in FIG. 4.

At S130, additional layers representing other “conversion” behaviors may be generated. These layers may be used to describe, for example, the “variable cost” conversions of inputs into outputs by a market and an internal operation. The market layer describes how a supply market and/or a demand market operate. A supply market converts cash into purchased products (e.g., labor, energy, fiber, emission allowances, etc.). A demand market converts products into cash. In accordance with another embodiment, one of the process elements may be a supply market to purchase offsets or allowances for emissions. An internal operation “variable cost” layer might include a paper machine that converts pulp, energy, and labor into paper and emissions of carbon dioxide and waste water. The conversion layers may also be used to describe, for example, “fixed cost” conversions. For example, a demand market has additional factors that may be modeled, such as the probability of acquiring a new customer in a year, the resources required to acquire a new customer, the resources to maintain a customer relationship, and so on. The product layer models the resources, e.g., development labor for enhancements and marketing efforts required to sustain an existing product given and the resources generated by a product.

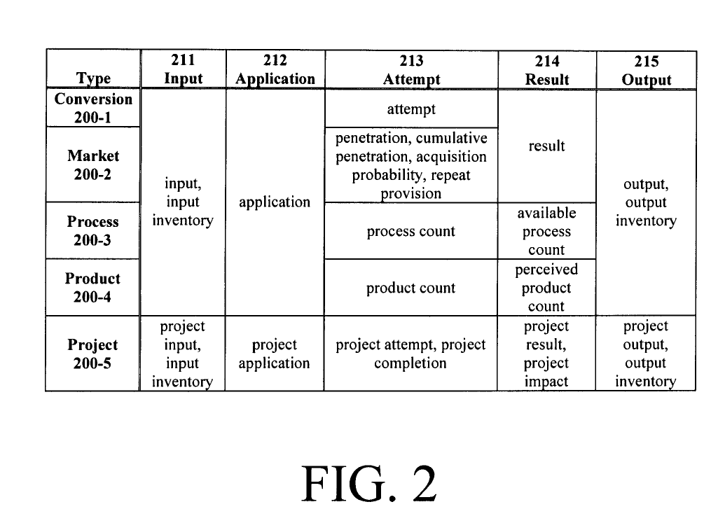

At S140, for each layer that was formed, the activity of converting inputs into outputs is determined. In accordance with an embodiment of the invention a five-step pattern conversion table is defined in order to capture a wide range of conversion behaviors. An exemplary conversion pattern 200 is shown in FIG. 2. The five conversion steps include Input 211, Application 212, Attempt 213, Result 214, and Output 215. These steps apply to the following layers: conversion 220-1, market 220-2, process 220-3, product 220-4, and project 220-5. The conversion layer 220-1 describes the conversion type of inputs into outputs for a typical variable cost activity. For example, a paper machine converts pulp, labor, and energy into paper, carbon dioxide and waste water.

The Input 211 step represents the inputs to the respective layer 220, e.g., raw material, labor, energy and machine capacity. The Application step 212 indicates which inputs a manufacturer needs in order to produce the products. The Attempt step 213 identifies the products the manufacturer attempts to make. The Result step 214 shows the products actually yielded. The Output step 215 specifies the outputs (e.g., numbers of stock keeping units) and by-products (e.g., carbon dioxide, waste water, etc.) of the respective layer 220. A cell in the table 200 represents a conversion parameter with lower and/or upper bounds of the respective conversion step 210 and layer 220.

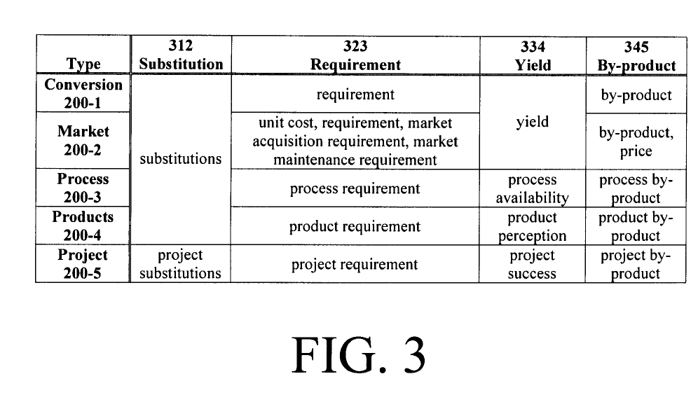

The transformations between two consecutive conversion steps are defined in a connection table. A non-limiting example for a connection table is provided in FIG. 3. The transform between Input step 211 and Application step 212 is defined through Substitutions 312. An example for a Substitution is replacing permanent labor with temporary labor. Resource requirements 323 connect the Application step 212 and the Attempt step 213. Yield 334 connects the Attempt step 213 and Result step 214, with the attempt to make products with good results. A byproduct relationship 345 connects the Result step 214 and Output step 215. The byproduct can be used to model emissions, scrap, and the like. As can be noted a connection is defined for each layer 220.

The conversion table 200, together with the connection table 300, provides a flexible approach to generalize variable and fixed cost behaviors and to capture project, process, and products and their interactions in the context of operational flows and market dynamics. For example, a product flow progresses from inputs to applications to the numbers of stock keeping units (SKUs) represented by the modeled products.

At S150, once the creation of the model is completed, an optimization process is applied on the model. This process generates a mathematical program that describes the economics and dynamics of the model by representing the activities in table 200 and connections in table 300 using a set of mathematical equations. The mathematical program may be, but is not limited to, a linear program, a mixed integer-linear program, a nonlinear program, a stochastic program, and the like. In addition, an objective function is computed for maximizing the profit of the organization while satisfying the equations of the mathematical program. Then, a linear programming optimization engine is executed to determine the best feasible values that satisfy the constraints and maximize the objective function. A non-limiting example describing the operation of the optimization process may be found in U.S. patent application Ser. No. 12/035,207, assigned to common assignee, and which is hereby incorporated for all that it contains.

The following is a non-limiting example for generating the model for joint profit and environmental optimization. The target is to model a manufacturer of assembled electric boards that wants to increase its profit while applying environmental factors. The environmental considerations are a lead-free wave soldering process and offsetting the carbon dioxide (CO₂) emissions of the factory. Offsetting the CO₂ emission may include buying or selling emissions in the emissions market. For example, the manufacturer may have a certain amount of emissions allowances (or cap) per year. Additional allowances can be purchased in the emissions market or, on the other hand, unused allowances can be sold or otherwise traded in the emissions market.

As mentioned above, in the modeling process, various layers are created. In the project layer, the manufacturer's initiatives are modeled as projects. The initiatives include at least implementing lead-free processes and offsetting the CO₂. A carbon footprint reduction project would reduce the CO₂ by-products from board production in the surface mount and/or wave soldering processes. The lead-free soldering project would reduce lead emissions in the wave soldering process.

In the process layer, processes are modeled as a network of nodes that represent process elements where connections between the process elements represent eligible product transfers. An exemplary diagram of such a network is provided in FIG. 4. The process elements include receiving, assembly cells, surface mounting, wave soldering, packaging, and shipping. Support functions such as Environmental, Health and Safety (EHS) are also modeled. In addition, customers of and suppliers to the manufacturer are modeled as external market processes. In order to offset the carbon dioxide emissions, a supply market to purchase carbon dioxide offsets is modeled. This market converts cash into carbon dioxide offsets, with the requirement connection serving as the unit cost (e.g., dollars per ton of CO₂). The cap on the lead emissions is also modeled as a Regulator process, where the Regulator provides a maximum lead emissions allowance.

As shown in FIG. 4, components transfer from suppliers 401 to receiving assembly cells 402, partially assembled boards transfer from surface mounting 403 to wave soldering 406 and then to assembling boards 405. Packaged products transfer from assembling boards 405 to shipping to customers 406. CO₂ offsets transfer from the carbon dioxide offset market 410 to an EHS department 411. CO₂ emissions transfer from the surface mounting 403 and wave soldering 404 activities to the EHS department 411, so they can be offset. Lead allowances transfer from the Regulator 412 to the EHS department 411. Customers 420 transfer cash to the division's finance function 421 and the finance function 421 transfers cash to suppliers 401 and to the carbon offset market 410. The carbon dioxide offset market 410 transfers CO₂ offsets to the EHS department 411.

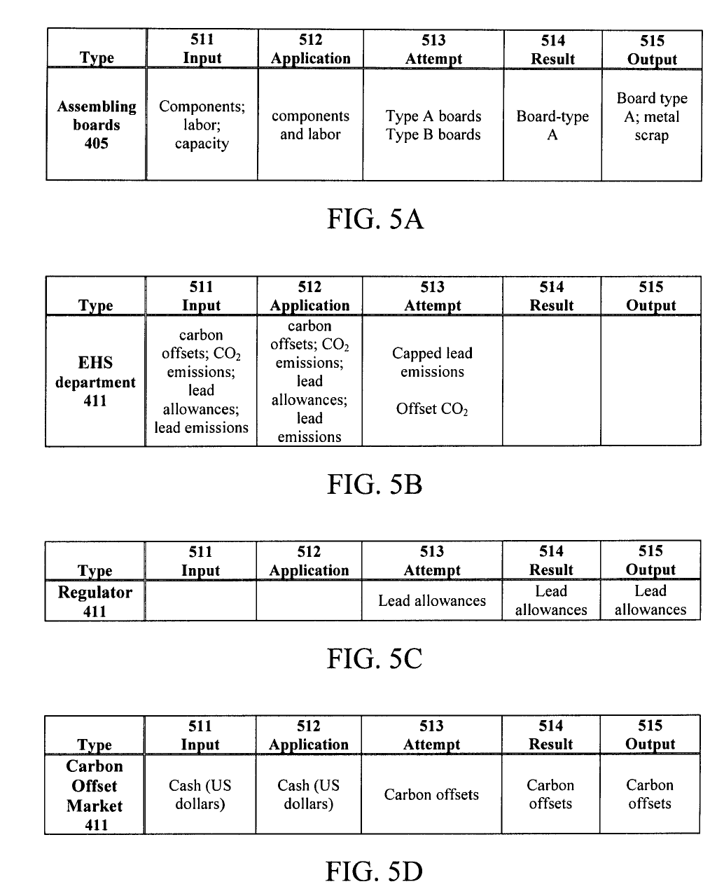

For each of the process elements shown in FIG. 4, a conversion table is generated that details the conversion activity for converting inputs into outputs. An exemplary conversion table that is applied to the assembling boards 405 process element is provided in FIG. 5A.

A manufacturing cell, that implements the assembly process, converts boards, electronic components and labor into circuit board assemblies, is shown. The Input step 511 represents the inputs to the process elements, i.e., components, labor and available capacity of the manufacturing cell. The Application step 512 indicates which inputs the manufacturing cell needs to produce a finished product. These inputs include components, labor and available capacity (i.e., asset-years of time available for production during the specified period). A non-limiting example of how capacity data is obtained may be found in U.S. patent application Ser. No. 12/035,207, assigned to common assignee, and which is hereby incorporated for all that it contains. The Attempt step 513 lists the type of assembled boards that the manufacturing cell attempts to produce using the required quantities of components, labor and available capacity. The Result step 514 presents the type of assembled boards and scrap that actually yield. In this case the results include only “type A” boards and metal scrap. The Output step 515 specifies the number assembled boards and amount of scrap. The conversion is performed using the connection table shown in FIG. 3.

The EHS department implements the process of offsetting the CO₂ and limiting lead emitted during the surface mounting and wave soldering. The CO₂ emission is a byproduct of the surface mounting and wave soldering processes. The Result step 514 shows boards produced and the Output step 515 outputs the numbers of stock keeping units of produced boards and amount of CO₂ emissions. Results and outputs are connected using two “by-product” relationships: 1) boards-to-boards; and, 2) boards-to-CO₂ emissions. In a similar fashion, emitted lead is a byproduct of the wave soldering activities. A cap on lead emissions is determined by the Regulator. In this case, the Result step 514 represents the lead allowances with an upper bound cap and the Output step 515 represents the lead allowances, and the byproduct connection connecting these lead allowances.

As shown in FIG. 4, transfers move the outputs of CO₂ emissions from surface mounting 403 and wave soldering 404 into the EHS department 411. Similarly, the amount of lead emissions is moved from the wave soldering 404 and input into the EHS department 411. These logical transactions allow for CO₂ offsetting and lead emission caps.

As shown in FIG. 5B, the input-to-output conversion activities performed by the EHS department 411 include: in the Input step 511 receiving as inputs carbon dioxide offsets, CO₂ emissions, lead allowances, and lead emissions. The Applications (i.e., Application step 512) are also of carbon dioxide offsets, CO₂ emissions, lead allowances and lead emissions. The Attempt step 513 is to offset the CO₂ and cap the lead emission. There are no substitutions, so the connections from steps 511 and 512 simply connect carbon dioxide offset with carbon dioxide offsets, CO₂ emissions with CO₂ emissions, lead allowances with lead allowances, and lead emissions with lead emissions. The connections from steps 512 and 513 connect one unit of CO₂ emitted with one unit of CO₂ attempted to be reduced; and one carbon dioxide offset with one unit of CO₂ emitted, effectively offsetting the emissions of CO₂. In addition connections between steps 512 and 513 connect one gram of lead emissions with one gram of lead allowances, thereby effectively capping the emission of lead. Since the CO₂ is offset and lead is capped in step 513, there are no CO₂ entries in the Result step 514 or the Output step 515.

Self explanatory conversion tables for the Regulator 412 and the Carbon Offset market 410 are provided in FIGS. 5C and 5D respectively.

The invention described herein can be implemented in hardware, software, firmware, or any combination thereof. The invention may be implemented as a computerized method executing in a computer and providing the benefits and outcomes described hereinabove in detail. One of skill in the art would recognize that the practicalities associated with the disclosed method require a computer be used to perform the computation. A computer for the purposes of this discussion may be simply understood as a processor and an associated tangible memory storing instructions. As is well known, the instructions are performed by the processor. Thus, in other words, an embodiment of the invention resides in a tangible computer memory storing instructions for optimizing business plans, which instructions, when executed by the computer processor, enable the processor to perform certain functions as set forth below. The method is thus an automated or computer implemented method (although, of course, interaction with users, either human or other computer systems, to one degree or another is foreseen).

What is claimed is:

1. A computer implemented method for generating a flexible model for joint profit and environmental optimization, comprising:
modeling one or more initiatives of an organization, said initiatives including at least one environmental initiative of the organization, to form a project layer;
modeling the operation of the organization to form a process layer with respect to the one or more initiatives; and
for each model layer, determining at least activities of converting inputs into outputs.

2. The computer implemented method of claim 1, further comprising:
modeling at least one market in which the organization operates to form a market layer; and
modeling at least one resource of the organization to form a product layer.

3. The computer implemented method of claim 2, further comprising:
optimizing the model layers based on the activities of converting inputs into outputs.

4. The computer implemented method of claim 1, wherein the activities of converting inputs into outputs are determined using a five-step conversion table and a connections table.

5. The computer implemented method of claim 4, wherein the five-step conversion table includes: an input step, an application step, an attempt step, a result step, and an output step.

6. The computer implemented method of claim 5, wherein the connections table describes transforms between two consecutive conversion steps, wherein the transforms include at least one of: a substitution, a resource requirement, yield, and a byproduct.

7. The computer implemented method claim 6, wherein the byproduct transform describes at least one of: emissions, toxins and resource waste.

8. The computer implemented method of claim 1, wherein the environmental initiatives comprise at least one of: limiting amount of emissions and toxins, reducing amount of resources waste, and offsetting emissions.

9. The computer implemented method of claim 1, wherein the process layer comprises a network of nodes, each node representing a respective process element.

10. A computer program product for generating a flexible model for joint profit and environmental optimization, the computer program product having computer instructions on a tangible computer readable medium, the instructions being adapted to enable a computer system to perform operations, comprising:
modeling one or more initiatives of an organization, said initiatives including at least one environmental initiative of the organization, to form a project layer;
modeling the operation of the organization to form a process layer with respect to the one or more initiatives; and
for each model layer, determining at least activities of converting inputs into outputs.

11. The computer program product of claim 10, further comprising:
modeling at least one market in which the organization operates to form a market layer; and
modeling at least one resource of the organization to form a product layer.

12. The computer program product of claim 11, further comprising:
optimizing the model layers based on the activities of converting inputs into outputs.

13. The computer program product of claim 10, wherein the activities of converting inputs into outputs are determined using a five-step conversion table and a connections table.

14. The computer program product of claim 13, wherein the five-step conversion table includes: an input step, an application step, an attempt step, a result step, and an output step.

15. The computer program product of claim 14, wherein the connections table describes transforms between two consecutive conversion steps, wherein the transforms include at least one of: a substitution, a resource requirement, yield, and a byproduct.

16. The computer program product claim 15, wherein the byproduct transform describes at least one of: emissions, toxins and resources waste.

17. The computer program product of claim 10, wherein the environmental initiatives comprise at least one of: limiting the amount of emissions and toxins, reducing the amount of resources waste, and offsetting emissions.

18. The computer program product of claim 10, wherein the process layer comprises a network of nodes, each node representing a respective process element.

19. A computer readable medium encoded with a data structure for converting inputs into outputs of a manufacturing process according to variable cost and fixed cost behaviors of the manufacturing process, wherein the data structure comprises five conversion steps including:
an input step for designating inputs to the manufacturing process;
an application step for designating which of the inputs are required for the manufacturing process;
an attempt step for identifying products that can be manufactured by the manufacturing process;
a result step for identifying an actual yielded products; and
an output step for designating outputs of the manufacturing process.

20. The computer readable medium of claim 19, wherein a connections table determines transforms between two consecutive steps, wherein the transforms include at least one of a transform between an input step and an application step, an application step and an attempt step, an attempt step and a result step; and a result step and an output step.

21. The computer readable medium of claim 20, wherein the byproduct transform describes at least one of: emissions and toxins emitted during the manufacturing process; and waste of the manufacturing process.
